(19) United States
(12) Patent Application Publication
(10) Pub. No.: US 2006/0048906 A1
(43) Pub. Date: Mar. 9, 2006

(54) Decorative accessory for a window treatment

(76) Inventor: Robert B. Mathieson, Buffalo, NY (US)

Correspondence Address: Robert P. Simpson, Esq.;Simpson & Simpson, PLLC, 5555 Main Street, Williamsville, NY, 14221-5406, US

(21) Appl. No.: 10/934,619

(22) Filed: Sep. 3, 2004

(51) Int. Cl. E06B 9/36

(52) U.S. Cl. 160/178.1 V

(57) ABSTRACT

A decorative accessory for a window treatment having a first area containing printed indicia desired to be viewed and a second area. The first and second areas are separated at least in part by a die cut that is coterminous with a line of demarcation. The combination of the die cut and line of demarcation separate the first and second areas.

### FIELD OF THE INVENTION

The present invention relates generally to decorative accessories, and, more particularly, to a decorative accessory for a window treatment.

### BACKGROUND

People have long used a variety of window treatments to decorate windows. Examples include blankets, drapes, vertical/horizontal blinds and a myriad of other treatments. Window treatments can be functional (e.g., blocking or filtering light, providing privacy or advertising a business), aesthetic, or both. Press-on decals, tinting and hanging objects are but a few examples of aesthetic modifications used to decorate a window.

Several decorative techniques and apparatus are directed at accessories for drapes and blinds. For example, U.S. Pat. No. 6,206,077 (Stanfill) discloses a method of positioning horizontal blind slats on a rack, and subsequently attaching an image overlay to the slats. The image overlay is then cut, providing a single image segment for each slat. After reinstallation in a window and closure of the blind, the image becomes viewable, while conversely, upon opening the blind, the image is made non-viewable.

U.S. Pat. No. 5,263,529 (Landis) discloses a similar invention wherein pre-cut press-on decals containing image segments are placed on each horizontal slat. In like fashion, the image is made viewable and non-viewable by opening and closing the blind.

Another example, although more complex and expensive to manufacture, is disclosed in U.S. Pat. No. 5,655,589 (Vartanian). Vartanian teaches a decorative blind containing hollow transparent slats, wherein decorative inserts may be placed. When the blind is closed, the decorative inserts are positioned to form an image. However, this patent discloses a specially manufactured blind system that cannot be retrofitted to an existing horizontal or vertical blind system.

While the aforementioned methods and apparatus do provide decorative accessories for a window treatment, they are expensive and/or cumbersome to implement. Additionally, the methods described supra can be used on only one set of blinds, preventing multiple applications, and thereby limiting usefulness.

Thus, there has been a long-felt need for a decorative accessory for a window treatment that is easy to apply, can be used more than once, and is inexpensive to manufacture.

### BRIEF SUMMARY OF THE INVENTION

The present invention broadly includes a decorative accessory for a window treatment having two areas, separated in part by a die cut, and further separated in part by a line of demarcation arranged coterminous with the die cut. The first area, containing printed indicia, is desired to be viewable, while the second area is not desired to be viewable.

A general object of the invention is to provide a decorative accessory for a vertical window blind.

Another object of the invention is to provide a decorative accessory for a horizontal window blind (Venetian blind).

A further object of the invention is to provide a decorative accessory for a window drapery.

Yet another object of the invention is to permit multiple applications of a decorative accessory for a window treatment.

An additional object of the invention is to provide an inexpensive means to manufacture a decorative accessory for a window treatment.

A further object of the invention is to provide a convenient means to package and distribute a decorative accessory for a window treatment.

Yet a further object of the invention is to provide a method of decorating a window treatment that is inexpensive and may be used more than once.

These and other objects, features, and advantages of the present invention will become readily apparent to one having ordinary skill in the art upon reading the detailed description of the invention in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front view of a first embodiment of the present invention, shown detachably secured to a vertical blind;

FIG. 2 is an enlarged view of the present invention shown in FIG. 1;

FIG. 3 is a plan view of the present invention shown in FIG. 1;

FIG. 4a is a perspective view of a segment of the decorative accessory for a window treatment shown in FIG. 3;

FIG. 4b is a plan view of the segment shown in FIG. 4a;

FIG. 4c is a cross-sectional view of the segment, taken generally along line 4c-4c of FIG. 4b;

FIG. 5 is a front view of a second embodiment of the present invention, shown detachably secured to a vertical blind;

FIG. 6 is a front view of a third embodiment of the present invention, shown detachably secured to a vertical blind;

FIG. 7 is a front view of a fourth embodiment of the present invention, shown detachably secured to a vertical blind;

FIG. 8 is a perspective view of the invention shown in FIG. 1, shown detachably secured to a drape;

FIG. 9 is a front view of a fifth embodiment of the present invention, shown detachably secured to a horizontal blind;

FIG. 10a is a front plan view of a sixth embodiment of the present invention, wherein the decorative accessory includes matching printed indicia on both its front and back sides;

FIG. 10b is a back plan view of the sixth embodiment of the present invention shown in FIG. 10a;

FIG. 11a is a front plan view of a seventh embodiment of the present invention, wherein the decorative accessory includes non-matching printed indicia on both its front and back sides;

FIG. 11b is a back plan view of the seventh embodiment of the present invention shown in FIG. 11a;

FIG. 12 is a front view of an eighth embodiment of the present invention, shown detachably secured to a vertical blind;

FIG. 13 is a front view of a ninth embodiment of the present invention, shown detachably secured to a vertical blind; and,

FIG. 14 is a perspective view of a tenth embodiment of the invention, illustrating how the elements of the decorative accessory can be packaged within a greeting card.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiment, it is to be understood that the invention as claimed is not limited to the preferred embodiment.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

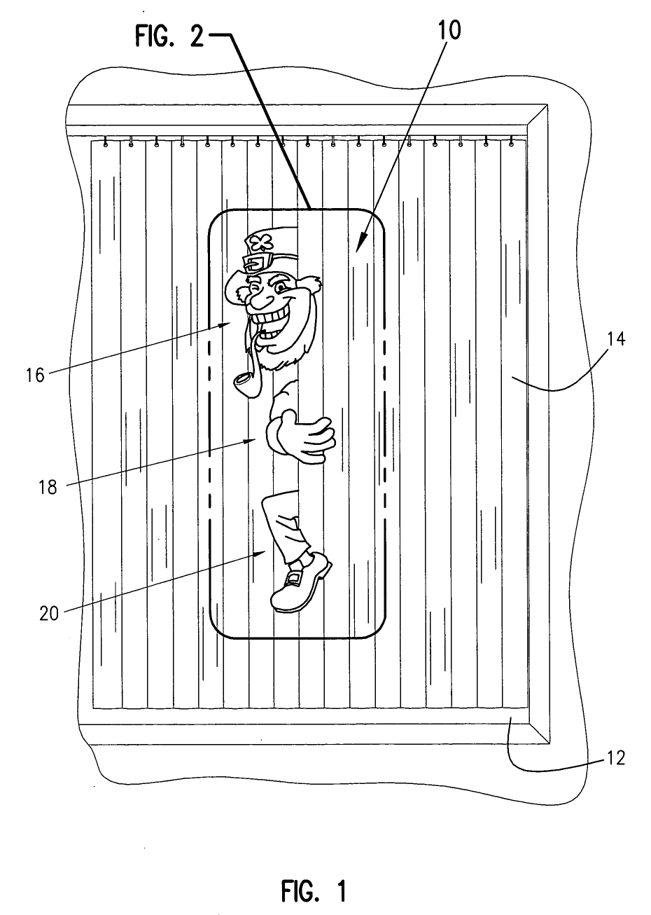

Adverting now to the figures, FIG. 1 is a front view of a first embodiment of the present invention, shown detachably secured to a vertical blind. Window 12 is covered in part by vertical window blinds 14. One aspect of the present invention permits decorative accessory 10 to be attached to vertical window blinds 14, and that aspect is described infra. Accessory segments 16, 18 and 20, when arranged according to the embodiment depicted in FIG. 1, display components of an image. By way of example, as shown in FIG. 1, the image is that of a leprechaun. It is to be understood, however, that the individual segments function cooperatively to form an image, and that the image may be any image, and is not limited to the particular characters (i.e., graphic letters, numbers, objects, symbols, persons or things) shown in the drawings. For example, the image could be landscapes, representations of objects, etc. The essence of the invention as claimed is that the individual components of the window treatment accessory form all or a part of an image desired to be displayed. It should also be appreciated that, while in FIG. 1, the individual segments of the accessory are all arranged so as to be secured along a single vertical blind slat, it is also contemplated that each segment could alternatively be secured to different blind slats to create a different image.

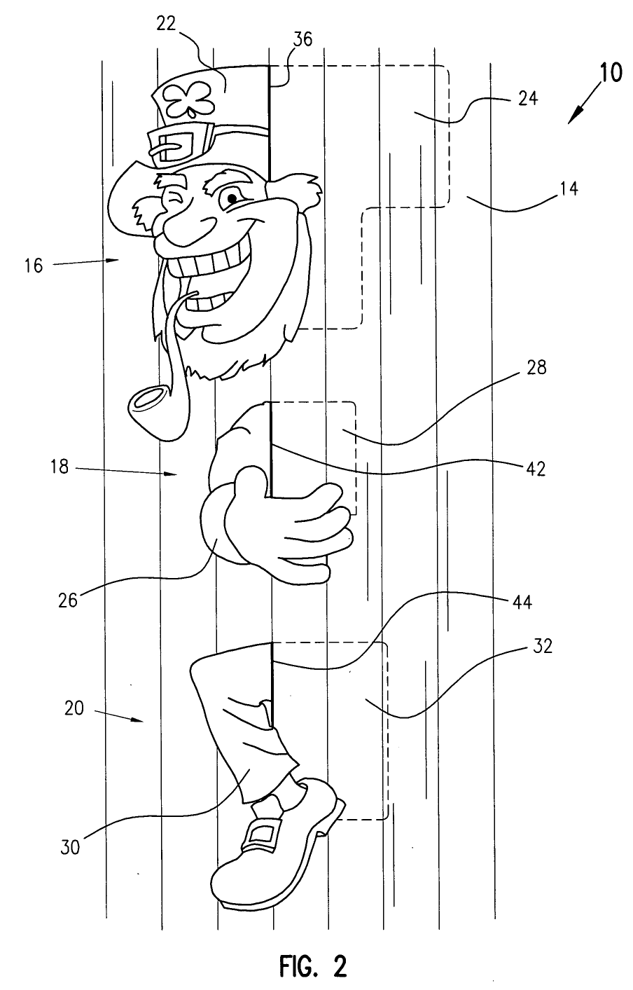

FIG. 2 is an enlarged view of the present invention shown in FIG. 1. In the first embodiment shown in the drawing, decorative assembly 10 comprises upper segment 16, middle segment 18 and lower segment 20. Upper segment 16 comprises two general areas: area 22 is seen to comprise printed indicia which is desired to be viewed, and area 24 (which may or may not include printed indicia) which is not desired to be viewed. Similarly, middle segment 18 comprises two general areas: area 26 is seen to comprise printed indicia which is desired to be viewed, and area 28 (which may or may not include printed indicia) which is not desired to be viewed. Lower segment 20 comprises two general areas: area 30 is seen to comprise printed indicia which is desired to be viewed, and area 32 (which may or may not include printed indicia) which is not desired to be viewed. As shown in FIGS. 1 and 2, in a first embodiment, one way of decorating a window is to arrange decorative accessory 10 in such a way such that viewable areas 22, 26 and 30, are located in front of vertical blinds 14 (and therefore viewable), while conversely, non-viewable areas 24, 28 and 32 are located behind the vertical blinds (and therefore occluded from view). Thus, in a first embodiment, a visual effect of “peeking around” the blinds is created by orienting the decorative accessory as described above.

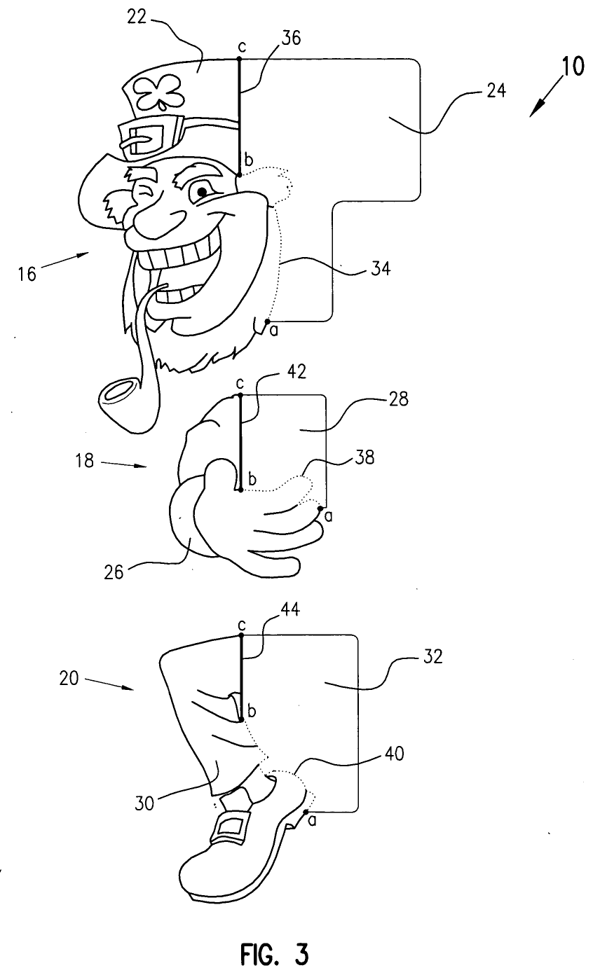

FIG. 3 is a plan view of the present invention shown in FIG. 1. As described previously each segment comprises two areas: an area desired to be viewed, and an area not desired to be viewed. Also in each segment, the two areas are separated by a line of demarcation and a die cut positioned coterminous with the line demarcation as described in detail herebelow.

Adverting to segment 16 in FIG. 3, line of demarcation 36 separates area 22 from area 24. Die cut 34 (shown in dotted line) similarly separates area 22 from area 24. In a preferred embodiment, line of demarcation 36 is a line segment (i.e., the finite part of a line between two points on the line). Also, in a preferred embodiment, die cut 34 may be irregular (i.e., lacking perfect symmetry or evenness) to conform to an image desired to be displayed. For example, in FIG. 3, it is seen that die cut 34 generally outlines the shape of the beard and hair of the leprechaun. Die cut 34 begins at point a and terminates at point b. Line of demarcation 36 begins at point b and terminates at point c. Thus, it is seen that die cut 34 and line of demarcation 36 are coterminous, i.e., they share and are joined at point b. It should be understood that although only a complete die cut is shown in the figures, other methods known in the art can be used to separate the two areas, e.g., perforation. In a preferred embodiment, line of demarcation 36 is substantially linear, since it functions as a means to align decorative segment 16 with a window treatment (see FIG. 2).

Similarly, in a preferred embodiment, each segment of decorative accessory 10 contains a die cut and a line of demarcation that are joined at a common point. For example, on segment 18, line of demarcation 42 separates area 26 from area 28. Die cut 38 (shown in dotted line) similarly separates area 26 from area 28. In a preferred embodiment, line of demarcation 42 is a line segment (i.e., the finite part of a line between two points on the line). As described supra, in a preferred embodiment, die cut 38 may be irregular to conform to an image desired to be displayed. In this instance, segment 18 of FIG. 3 contains die cut 38, which generally outlines the shape of the fingers of the leprechaun. Die cut 38 begins at point a and terminates at point b. Line of demarcation 42 begins at point b and terminates at point c. Thus, it is seen that die cut 38 and line of demarcation 42 are coterminous, i.e., they share and are joined at point b. Lastly, on segment 20, line of demarcation 44 separates area 30 from area 32. Die cut 40 (shown in dotted line) similarly separates area 30 from area 32. In a preferred embodiment, line of demarcation 44 is a line segment (i.e., the finite part of a line between two points on the line). As described above, in a preferred embodiment, die cut 40 may be irregular to conform to an image desired to be displayed. In this instance, segment 20 of FIG. 3 contains die cut 40, which generally outlines the shape of the pants, ankle and shoe of the leprechaun. Die cut 40 begins at point a and terminates at point b. Line of demarcation 44 begins at point b and terminates at point c. Thus, it is seen that die cut 40 and line of demarcation 44 are coterminous, i.e., they share and are joined at point b.

As described previously, the three segments 16, 18 and 20 function cooperatively to form a composite image. In the embodiment shown in FIGS. 1, 2 and 3, for example, the composite image shown is that of a leprechaun, segment 16 includes a display of the face of the leprechaun; segment 18 includes a display of the right hand and arm of the leprechaun; and, segment 20 includes a display of the right foot, shoe and leg of the leprechaun. As perhaps best shown in FIG. 1, the three segments function cooperatively together, when secured to a window treatment, to display components of a composite image, i.e., a leprechaun peeking around a vertical blind (although the image itself could be of virtually anything, and is not limited to a leprechaun, or any single object).

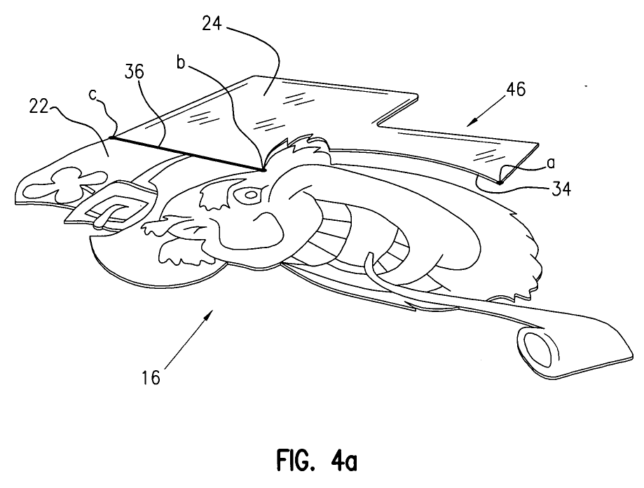

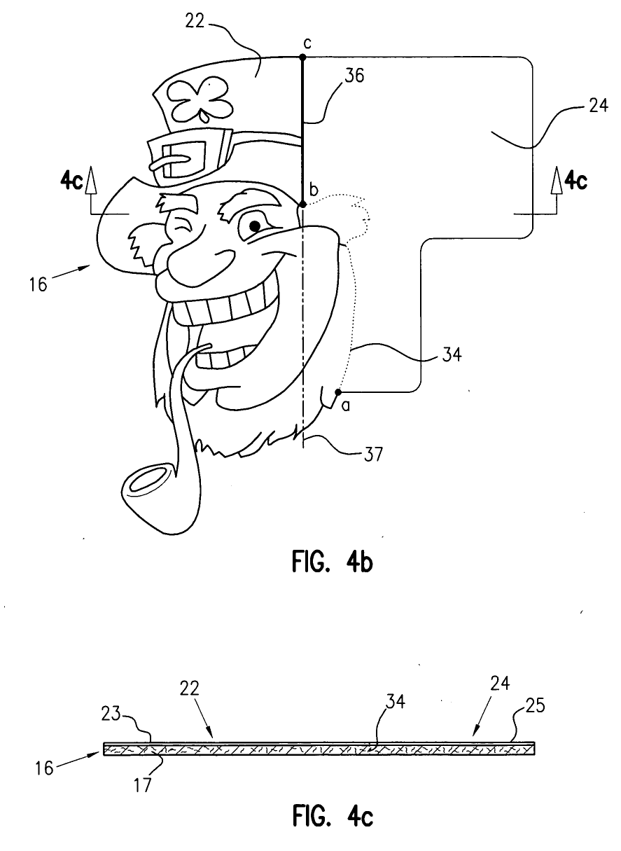

The structural aspects that permit a decorative segment to grip a window treatment are best illustrated in FIGS. 4a and 4b. FIG. 4a is a perspective view of segment 16 of the decorative accessory for a window treatment shown in FIG. 3, while FIG. 4b is a plan view of the segment shown in FIG. 4a. As described above, segment 16 comprises two areas, 22 and 24, respectively, which are separated in part by line of demarcation 36 and further separated in part by die cut 34. The combination of the separation of die cut 34 and the contiguous substrate across line of demarcation 36 permits portion 46 of area 24 to be flexed. By flexing portion 46, a torsion is created in the region of point b (the coterminous point of die cut 34 and line of demarcation 36). Similar to attaching a paper clip to a piece of paper, the torsion force permits a segment to grip a window treatment.

Another aspect of the invention, the combination of the location of the die cut and the line of demarcation, permits printed indicia to fall on both sides of an extrapolation of the line of demarcation. Adverting now to FIG. 4b, dashed line 37 is an extrapolation of line of demarcation 36. Viewable area 22 contains printed indicia, and that indicia falls on both sides of dashed line 37, i.e., dashed line 37 transects area 22. This arrangement creates functional relationships between the printed indicia and substrate. For example, a functional relationship created by the aforementioned transection is the optical effect of “peeking around” the blind slats, i.e., the image or character appears to be wrapping around the blind.

Another example of functionality is perhaps best understood in view of FIGS. 2 and 4b. In the embodiment shown in these figures, line of demarcation 36 provides an alignment tool that defines where to place the accessory on a window treatment, typically based on an image orientation. By positioning segment 16 on a window treatment, as indicated by line of demarcation 36, desired to be viewable area 22 is visible, and not desired to be viewable area 24 is occluded. Yet another example of functionality is line of demarcation 36 and die cut 34 create the separation between desired to be viewable area 22 from not desired to be viewable area 24, i.e., the dividing line between the two areas.

FIG. 4c is a cross-sectional view of the segment, taken generally along line 4c-4c of FIG. 4b. Substrate 17 may be selected from a number of different material types, for example, paper, paperboard, sheet metal or plastic, however the material choice is not limited to this list. Although, the material selected should be sufficiently rigid to generate adequate torsion force, described supra, to permit gripping and retaining the segment on a window treatment, i.e., supporting the segment's weight. Further shown in FIG. 4c is that die cut 34, made through substrate 17, separates desired to be viewable area 22 from not desired to be viewable area 24. Areas 22 and 24 comprise both substrate 17, and printed material 23 and 25, respectively. In this first embodiment, printed material 23 is desired to be viewable, and as such, comprises printed indicia resembling an image of a leprechaun's face (see FIG. 4b). Conversely, printed material 25 is not desired to be viewable, however, it may or may not contain printed indicia. In this embodiment, no printed indicia are shown, although other embodiments, wherein area 24 contains printed indicia, are discussed below. In the first embodiment, shown in FIGS. 1, 2, 3, 4a, 4b and 4c, each segment includes features similar to those shown for segment 16, such as a die cut, a line of demarcation, a coterminous point and two areas. However, for the sake of brevity, such features are not described in further detail, as they are structurally and functionally similar to the features described for segment 16 supra.

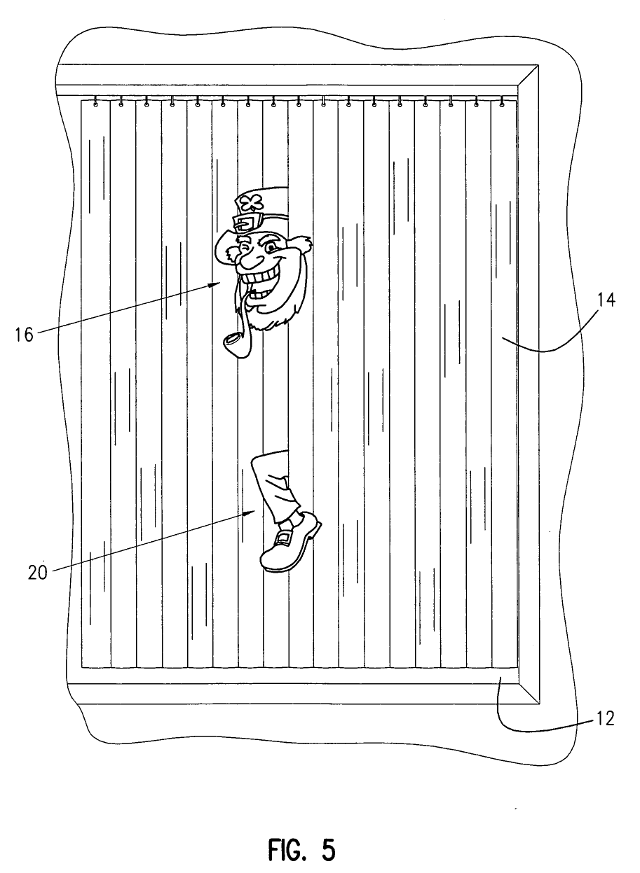

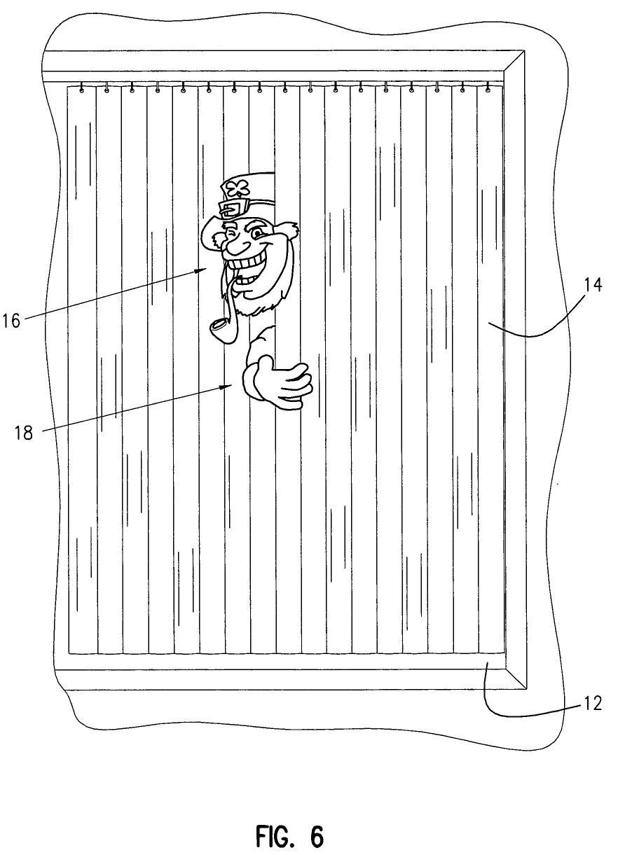

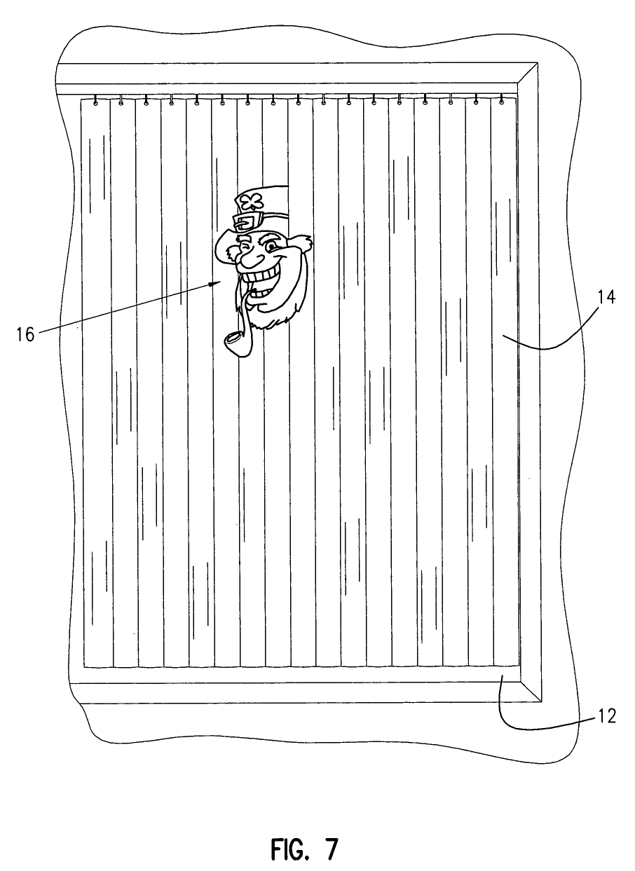

FIGS. 5, 6, and 7 are front views of a second, third and fourth embodiment, respectively, of the present invention, each shown detachably secured to a vertical blind. In these embodiments, the aspect that a single segment or a plurality of segments may form a character image is shown. Vertical blinds 14 substantially cover window 12 in each figure. A second embodiment, FIG. 5, comprises the combination of segments 16 and 20, while a third embodiment, FIG. 6, comprises the combination of segments 16 and 18, and lastly a fourth embodiment, FIG. 7, comprises only segment 16. Although only a leprechaun character is shown in the figures, one of ordinary skill in the art is aware that the scope of the invention is not limited to a specific character image, as many other characters may be used, e.g., duck, Santa Claus, ghost, etc.

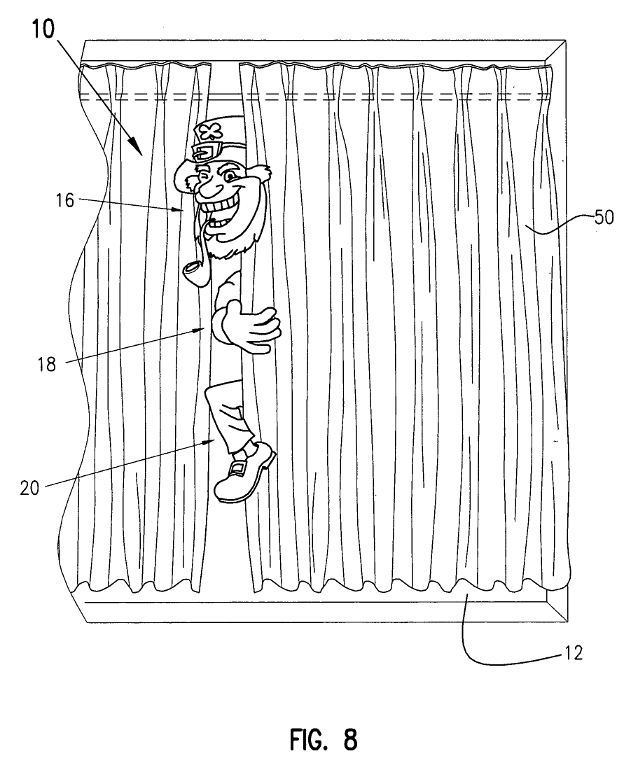

FIG. 8 is a perspective view of the invention shown in FIG. 1, shown detachably secured to a drape. Drapery 50 substantially covers window 12. Similar to FIGS. 1, 2, 5, 6 and 7, the segments are affixed to a window treatment. However, the window treatment taught in FIG. 8 is drapery 50, not vertical blinds. By similar means as described above, segments 16, 18, and 20 are affixed to drapery 50, thereby creating a character image. For example, the segments are aligned to the edge of the drapery with their respective lines of demarcation.

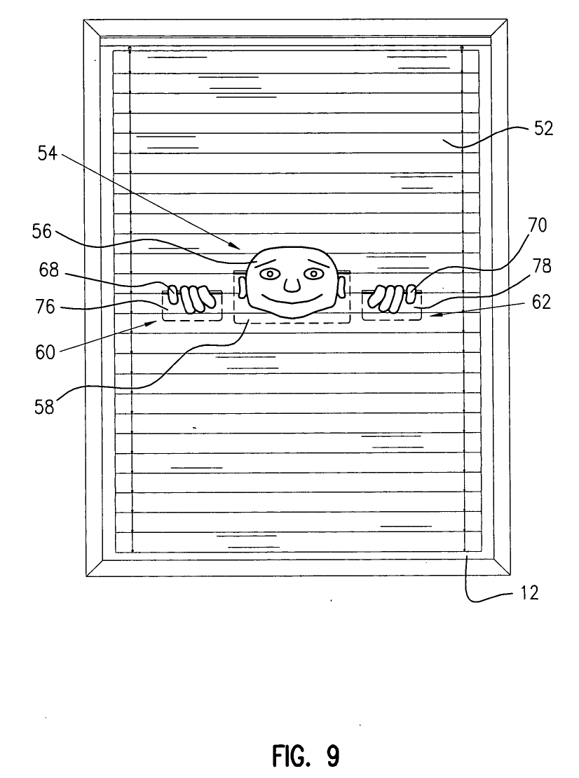

An additional aspect of the present invention is the ability to couple to not only a substantially vertical edge, but also a substantially horizontal edge, or any angle therebetween. FIG. 9 is a front view of a fifth embodiment of the present invention, shown detachably secured to a horizontal blind. In this instance, window 12 is covered in part by horizontal blinds 52 (also known as Venetian blinds). As described above, each image segment consists of two areas, the desired to be viewable and the not desired to be viewable, e.g., head segment 54 is made up of desired to be viewable area 56 and not desired to be viewable 58. Similarly, hand segments 60 and 62 consist of desired to be viewable areas 68 and 70, respectively, and not desired to be viewable areas 76 and 78, respectively. In this embodiment, the invention provides a character image that appears to “peek around” the top of the window treatment.

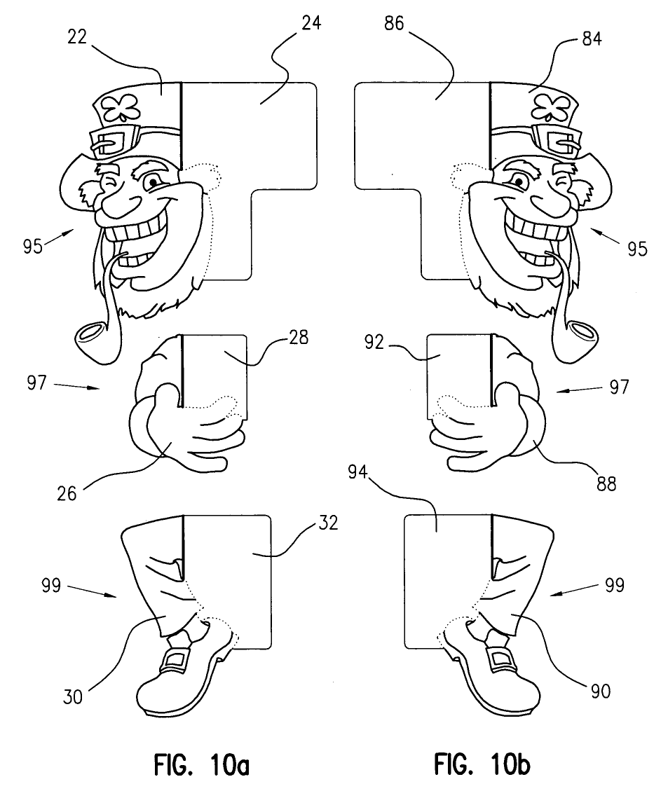

Depending on the desired perspective for “peeking around”, printed indicia may be on either or both sides of a segment. A sixth embodiment is perhaps best understood in view of FIGS. 10a and 10b. FIG. 10a is a front plan view of a sixth embodiment of the present invention, wherein the decorative accessory includes matching printed indicia on both its front and back sides, and, FIG. 10b is a back plan view of the sixth embodiment of the present invention shown in FIG. 10a. It should be noted that although FIG. 10a is referred to as the front surface, either surface shown in FIGS. 10a or 10b may function as the front or the back surface, i.e., the reference is for the purpose of this discussion only. The features shown in FIG. 10a are not described in further detail, as they are structurally and functionally similar to the features described for FIG. 3 supra. FIG. 10b shows the back surfaces of the image segments 16, 18 and 20. Being substantially similar to the front surfaces, the back surfaces also consist of two areas. For example, the back surface of segment 16 consists of desired to be viewable area 84 and not desired to be viewable area 86. Similarly, segments 18 and 20 are made up of desired to be viewable areas 88 and 90, respectively, and not desired to be viewable areas 92 and 94, respectively. This embodiment permits the character image to be oriented with either surface facing the viewing direction, i.e., the character image is permitted to “peek around” either side of a window treatment, bottom/top or left/right.

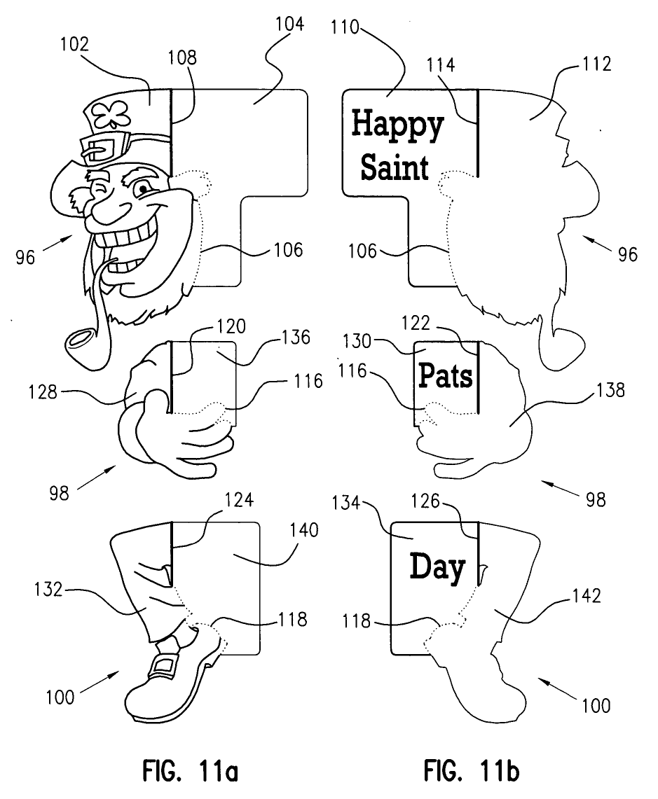

Another embodiment allows simultaneously viewing multiple images, depending upon the viewing direction of the segments. This aspect is best understood in view of FIGS. 11a and 11b. FIG. 11a is a front plan view of a seventh embodiment of the present invention, wherein the decorative accessory includes printed indicia on both its front and back sides, and, FIG. 11b is a back plan view of the seventh embodiment of the present invention shown in FIG. 11a. Again, it should be noted that although FIG. 11a is referred to as the front surface, either surface shown in FIG. 11a or 11b may function as the front or the back surface, i.e., the reference to front or back is for the purpose of this discussion only. FIGS. 11a and 11b show image segments 96, 98 and 100. Similar to aspects described above, each segment consists of two areas, the desired to be viewable and the not desired to be viewable. For example, the front surface of upper segment 96 consists of desired to be viewable area 102 and not desired to be viewable area 104. Likewise, the front surface of upper segment 96 is separated in part by die cut 106 and further separated by line of demarcation 108. Conversely, the back surface of upper segment 96 consists of desired to viewable area 110 and not desired to be viewable area 112. Similar to the front surface, the back surface is also separated in part by die cut 106 and further separated by line of demarcation 114. Therefore, an aspect of the present invention is desired to be viewable area 102 of the front surface corresponds with not desired to be viewable area 112 of the back surface. Similarly, not desired to viewable area 104 of the front surface corresponds with desired to be viewable area 110 of the back surface. In configuring a segment as described, the simultaneous viewing of an image on both sides of a window treatment is permitted.

As FIGS. 11a and 11b show, each segment is configured in the aforementioned arrangement. For example, middle segment 98 contains desired to be viewable areas 128 and 130 and not desired to be viewable areas 136 and 138. The areas of segment 98 are separated in part by die cut 116, and further separated by lines of demarcation 120 and 122. Likewise, lower segment 100 contains desired to be viewable areas 132 and 134 and not desired to be viewable areas 140 and 142. The areas of segment 100 are separated in part by die cut 118, and further separated by lines of demarcation 124 and 126.

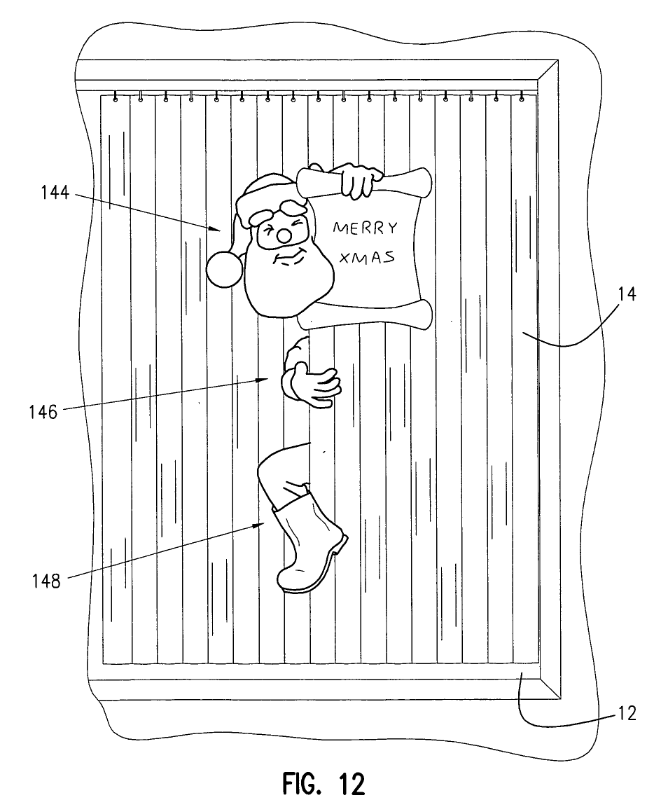

FIG. 12 is a front view of an eighth embodiment of the present invention, shown detachably secured to a vertical blind. As described supra, the present invention is not limited to a specific character or image, e.g., a leprechaun. FIG. 12 teaches a “Santa Claus” character image. The combination of segments 144, 146 and 148, when positioned as shown in the figure, form an image of “Santa Claus”.

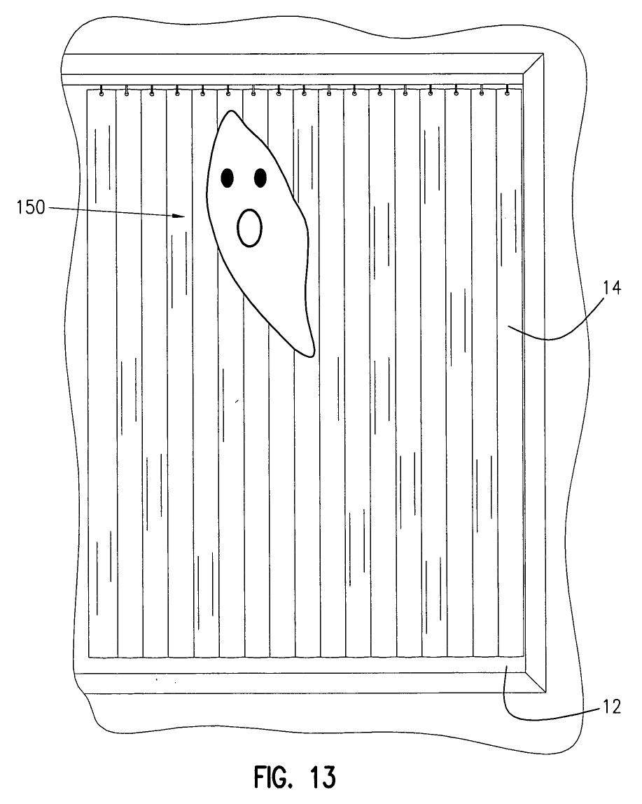

FIG. 13 is a front view of a ninth embodiment of the present invention, shown detachably secured to a vertical blind. As described supra, the image may be formed from a single segment or a plurality of segments. FIG. 13 shows a character image formed by a single segment. In this instance, the “ghost” image is created by the positioning of segment 150 on vertical blinds 14.

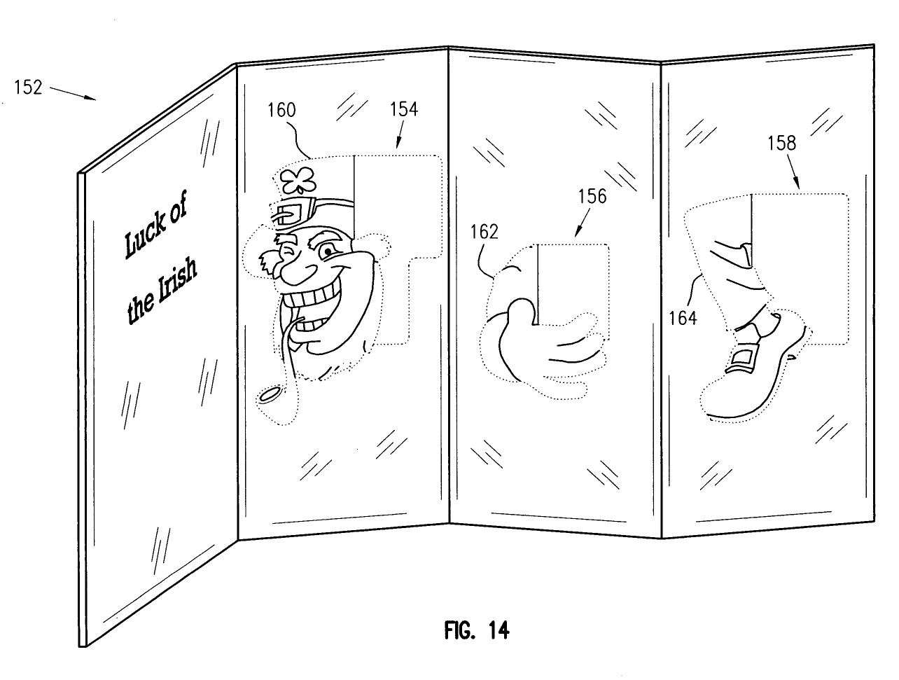

FIG. 14 is a perspective view of a tenth embodiment of the invention, illustrating how the elements of the decorative accessory can be packaged within a greeting card. Greeting card 152 contains segments 154, 156 and 158. Edges 160, 162 and 164 of segments 154, 156 and 158, respectively, are weakened to permit the detachment of each segment from the greeting card. Upon detachment, the segments can be arranged according to the aforementioned methods to form a present invention decorative accessory for a window treatment.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed:

1. A decorative accessory for a window treatment comprising:
a substrate having a first area containing a decorative printed indicia desired to be viewable; and
a second area not desired to be viewable, said first and second areas separated in part by a die cut, said die cut terminating at a line segment separating said first and second areas.

2. The decorative accessory for a window treatment recited in claim 1 wherein said substrate is defined by a weakened area on a sheet such that it can be easily separated from said sheet.

3. The decorative accessory for a window treatment recited in claim 1 wherein said substrate is paper.

4. The decorative accessory for a window treatment recited in claim 1 wherein said substrate is paperboard.

5. The decorative accessory for a window treatment recited in claim 1 wherein said substrate is plastic.

6. The decorative accessory for a window treatment recited in claim 1 wherein said substrate is metal.

7. The decorative accessory for a window treatment recited in claim 1 wherein said substrate is laminated.

8. The decorative accessory for a window treatment recited in claim 1 wherein said die cut is irregular.

9. The decorative accessory for a window treatment recited in claim 1 wherein said die cut is linear.

10. The decorative accessory for a window treatment recited in claim 1 said decorative printed indicia further comprising a character.

11. The decorative accessory for a window treatment recited in claim 1 wherein an extrapolation of said line segment transects said first area.

12. A decorative accessory in combination with a window treatment comprising:
a substrate having a first area containing a decorative printed indicia desired to be viewable;
a second area not desired to be viewable, said first and second areas separated in part by a die cut, said die cut terminating at a line segment separating said first and second areas; and,
a window treatment.

13. The decorative accessory for a window treatment recited in claim 12 wherein said substrate is defined by a weakened area on a sheet such that it can be easily separated from said sheet.

14. The decorative accessory for a window treatment recited in claim 12 wherein said substrate is paper.

15. The decorative accessory for a window treatment recited in claim 12 wherein said substrate is paperboard.

16. The decorative accessory for a window treatment recited in claim 12 wherein said substrate is plastic.

17. The decorative accessory for a window treatment recited in claim 12 wherein said substrate is metal.

18. The decorative accessory for a window treatment recited in claim 12 wherein said substrate is laminated.

19. The decorative accessory for a window treatment recited in claim 12 wherein said die cut is irregular.

20. The decorative accessory for a window treatment recited in claim 12 wherein said die cut is linear.

21. The decorative accessory for a window treatment recited in claim 12 said decorative printed indicia further comprising a character.

22. The decorative accessory for a window treatment recited in claim 12 wherein an extrapolation of said line segment transects said first area.

23. The decorative accessory for a window treatment recited in claim 12 wherein the window treatment is a vertical blind.

24. The decorative accessory for a window treatment recited in claim 12 wherein the window treatment is a horizontal (Venetian) blind.

25. The decorative accessory for a window treatment recited in claim 12 wherein the window treatment is a drapery.

26. A decorative accessory for a window treatment comprising:
a substrate having a first area containing a decorative printed indicia desired to be viewable;
a second area not desired to be viewable, said first and second areas separated in part by a die cut, said die cut terminating at a line segment separating said first and second areas; and,
wherein an extrapolation of said line segment transects said first area.

27. The decorative accessory for a window treatment recited in claim 26 wherein said substrate is defined by a weakened area on a sheet such that it can be easily separated from said sheet.

28. The decorative accessory for a window treatment recited in claim 26 wherein said substrate is paper.

29. The decorative accessory for a window treatment recited in claim 26 wherein said substrate is paperboard.

30. The decorative accessory for a window treatment recited in claim 26 wherein said substrate is plastic.

31. The decorative accessory for a window treatment recited in claim 26 wherein said substrate is metal.

32. The decorative accessory for a window treatment recited in claim 26 wherein said substrate is laminated.

33. The decorative accessory for a window treatment recited in claim 26 wherein said die cut is irregular.

34. The decorative accessory for a window treatment recited in claim 26 wherein said die cut is linear.

35. The decorative accessory for a window treatment recited in claim 26 said decorative printed indicia further comprising a character.

36. A method of decorating a window treatment with an accessory comprising:
a) engaging a window treatment with a decorative accessory, said decorative accessory comprising a first area containing a decorative printed indicia desired to be viewable and a second area not desired to be viewable, said first and second areas separated at least in part by a line segment; and,
b) aligning said window treatment with said line segment partially delineating said first and second areas.

37. The method of treating a window with a decorative accessory recited in claim 36 wherein said window treatment comprises a drapery.

38. The method of treating a window with a decorative accessory recited in claim 36 wherein said window treatment comprises a vertical blind.

39. The method of treating a window with a decorative accessory recited in claim 36 wherein said window treatment comprises a horizontal (Venetian) blind.
